(19) United States
(12) Patent Application Publication
(10) Pub. No.: US 2019/0311891 A1
(43) Pub. Date: Oct. 10, 2019

(54) ANALYZER

(71) Applicant: SHIMADZU CORPORATION, Kyoto-shi, Kyoto (JP)

(72) Inventor: Natsuyo ASANO, Kyoto-shi (JP)

(73) Assignee: SHIMADZU CORPORATION, Kyoto-shi, Kyoto (JP)

(21) Appl. No.: 16/316,657

(22) PCT Filed: Jul. 11, 2016
(86) PCT No.: PCT/JP2016/070450

§ 371 Date: Jan. 10, 2019

(51) Int. Cl. H01J 49/00; H01J 49/40; H01J 49/42

(52) U.S. Cl. CPC H01J 49/005; H01J 49/4215; H01J 49/40; H01J 49/0031

(57) ABSTRACT

When an optimal value of collision energy (CE) corresponding to an MRM transition is automatically determined, a tuning CE value determining unit (31) determines multiple CE values to be subjected to MRM measurement so that the rate of change in CE value is approximately constant within a predetermined CE value variation range, and a tuning control unit (32) performs MRM measurement using the determined CE values. Conventionally, the step width of the CE value in tuning is constant; however, in the present invention, the step width is increased to be wider in a range in which the CE value is relatively large than a range in which the CE value is small.

### TECHNICAL FIELD

The present invention relates to an analyzer, and more specifically, to an analyzer that can change the value of a certain parameter related to analysis step-by-step and obtain a result of the analysis with respect to each value of the parameter. The present invention is suitable for, for example, mass spectrometers such as tandem quadrupole mass spectrometers and Q-TOF mass spectrometers that are capable of changing collision energy to dissociate ions in a collision cell step-by-step.

### BACKGROUND ART

A tandem quadrupole mass spectrometer includes quadrupole mass filters on opposite sides of a collision cell in which ions are dissociated by collision-induced dissociation (CID), and can cause ions (precursor ions) having a particular mass-to-charge ratio selected in the first-stage quadrupole mass filter to collide with collision gas in the collision cell, thereby dissociating the ions, and, in the second-stage quadrupole mass filter, separate and detect the generated product ions according to the mass-to-charge ratio. Furthermore, a Q-TOF mass spectrometer replaces the second-stage quadrupole mass filter in the tandem quadrupole mass spectrometer with a time-of-flight mass spectrometer.

In such a mass spectrometer, the efficiency of ion dissociation in a collision cell depends on energy that precursor ions have at the point of introduction into the collision cell (hereinafter, referred to idiomatically as “collision energy”); if the dissociation efficiency is low, the amount of generated product ions is small, and the detection sensitivity becomes low. Furthermore, in general, the form of ion dissociation by CID differs according to collision energy; therefore, it goes without saying that an optimal value of collision energy differs if generated precursor ions differ due to the difference in a compound, but even if a compound is of the same type and precursor ions are the same, an optimal value of collision energy differs if product ions that one wants to observe are different. Accordingly, when multiple reaction monitoring (MRM) measurement is performed, an optimal value of collision energy for a target compound is checked in advance with respect to each MRM transition (a combination of a precursor ion and a product ion), and control of switching the collision energy according to MRM transition set when a target sample is analyzed is performed.

In general, conventionally, in tuning where an optimal collision energy value (hereinafter, abbreviated as a “CE value” accordingly) is checked, while changing the CE value step-by-step by a predetermined step width over a predetermined CE value range, an ionic strength signal is acquired by making MRM measurement under the CE value, and a CE value that leads to a maximum ionic strength signal is found as an optimal CE value (incidentally, the CE value is not actually changed step-by-step, and the value of direct-current voltage applied to, for example, an inlet electrode of a collision cell or an ion guide provided in the collision cell is changed step-by-step; however, in this specification, this voltage value is also idiomatically referred to as a CE value, and the term “voltage value” is sometimes used as it is). In this method, if the step width of the CE value is large, it may fail to find a CE value capable of obtaining sufficiently high dissociation efficiency. On the other hand, if the step width of the CE value is small, it is possible to find a CE value capable of obtaining sufficiently high dissociation efficiency; however, there is a problem that tuning is time-consuming because of an increase in the number of repetitions of the measurement.

To solve the above-described problem, in a mass spectrometer according to Patent Literature 1, first, MRM measurement is performed while changing the CE value by a rough step width, and a CE value that leads to the maximum ionic strength is found by comparing the ionic strength. After that, MRM measurement is performed while changing the CE value by a minute step width in a narrow CE value range centering on the found CE value, and a CE value that leads to the maximum ionic strength is found by comparing the ionic strength. By performing rough and close scans of CE values in two stages in this way, an optimal CE value can be found through fewer measurements.

However, although the number of measurements is reduced, such a method is complex in algorithms of both control and data processing as compared with a process of selecting a CE value that leads to the highest ionic strength from multiple CE values. Furthermore, in a case where a relationship between ionic strength and CE value is special (for example, there are two or more peaks of ionic strength in a predetermined CE value range, or a peak of ionic strength is steep with respect to a change in the CE value), it may fail to properly find an optimal CE value.

Such a problem is not limited to optimization of the CE value, and applies to all control parameters required to be optimized in a mass spectrometer, such as lens voltage applied to an ion lens, declustering potential (DP), gas flow rate of nebulizing gas or dry gas used in an ion source by an ionization method such as an electrospray ionization method or an atmospheric pressure chemical ionization method, heating temperature of the ion source or a heating capillary that transports generated ions from the ion source to a subsequent stage, and laser intensity in a case of using an atmospheric pressure photoionization (APPI) ion source. Furthermore, the problem is not only for mass spectrometers but also various other analyzers, for example, analyzers in general such as gas chromatography systems, liquid chromatography systems, and spectrometers that need to optimize the value of a parameter related to analysis.

Moreover, besides the optimization of the CE value, the mass spectrometer may use an analysis result obtained by making an MS/MS analysis under multiple different CE values. For example, Non Patent Literature 1 discloses a method in which, in a case where a measurement object is glycopeptide or N-linked oligosaccharide, the strength of a product ion (an oxonium ion) derived from glycan is measured while changing the CE value, and a relationship between CE value and ionic strength is graphed, and then, the glycan structure is inferred by using the fact that the strength change is specific to the glycan structure. Furthermore, Non Patent Literature 2 discloses that a mass spectrum that can observe diverse product ions while leaving peaks of precursor ions is created by integrating mass spectrums (MS/MS spectrums) obtained under different CE values.

When such an analysis is performed, if information for creating an intended graph or mass spectrum is obtained through fewer measurements, the efficiency of analysis is improved.

### CITATION LIST

### Patent Literature

Patent Literature 1: WO 2013/065173

### Non Patent Literature

Non Patent Literature 1: “Erexim™ Application Suite. Glycan Qualitative and Quantitative Analysis Software for LCMS-8060/8050”, [online], Shimadzu Corporation, [searched on H28.6.29.], the Internet <URL: http://www.an.shimadzu.co.jp/lcms/erexim/index.htm>
Non Patent Literature 2: “Convenient Features for Impurity Analysis “Stepped Collision Energy””, [online], Thermo Fisher Scientific Inc., [searched on H28.6.1.], the Internet <URL: https://www.thermofisher.com/content/dam/LifeTech/japan/FAQs/_PDFs/Stepped-Collision-Energy-JA.pdf>
Non Patent Literature 3: “A New, Fast and Sensitive LC/MS/MS Method for the Accurate Quantitation and Confirmation of Fluoroquinolone Antibiotics in Food Products” [online], Applied Biosystems Inc., [searched on H28.7.11.], the Internet <URL: http://www3.appliedbiosystems.com/cms/groups/psm_marketing/documents/generaldocuments/cms_050556.pdf>

### SUMMARY OF INVENTION

### Technical Problem

The present invention has been made to solve the above-described problems, and a main object of the invention is to provide an analyzer that can efficiently find an optimal value of a parameter value, such as a CE value, through fewer measurements without performing complex control or data processing.

Furthermore, another object of the invention is to provide an analyzer that can obtain a proper analysis result efficiently, i.e., through fewer measurements when information on a sample is obtained based on results of respective measurements or analyses performed under multiple different parameter values.

### Solution to Problem

An analyzer according to a first aspect of the present invention developed for solving the previously described problem has a function of optimizing a value of a parameter that is one of analysis conditions so as to produce an excellent analysis result, and includes:

a) an analysis controller that controls units of the analyzer to perform analysis using each of multiple numerical values determined so that a rate of change in numerical value to be the value of the parameter is approximately constant and acquires respective analysis results; and

b) an optimal value determining unit that finds an optimal value of the value of the parameter based on the analysis results obtained under control of the analysis controller.

The analyzers according to the first aspect and a below-mentioned second aspect of the present invention can be any type of analyzer as long as it can perform measurement or analysis while changing the value of a parameter that is one of analysis conditions. Furthermore, in most cases, the parameter value is a value of voltage applied to an element such as an electrode included in the analyzer or applied to drive a components or element included in the analyzer. For example, in a case where the analyzer according to the present invention is a mass spectrometer, the parameter value may be a value of voltage for manipulating ions that are an analysis object.

As an example, the analyzer according to the present invention can be a mass spectrometer including a collision cell in which ions derived from a sample are dissociated, for example, be a triple quadrupole mass spectrometer or a Q-TOF mass spectrometer, and the parameter value can be a value of voltage that determines a value of collision energy (a CE value) used when ions are dissociated in the collision cell. Furthermore, in a case where the analyzer according to the present invention is a mass spectrometer, the parameter value may be a declustering potential or a value of voltage applied to an ion transport optical system such as an ion guide for transporting ions that are an analysis object to a subsequent stage, a sampling cone, and a skimmer with an orifice formed in its apex, or a deflector that deflects the track of ions. Incidentally, as disclosed in Non Patent Literature 3, etc., the value of voltage that is the parameter value generally differs according to compound, namely, is a value of compound-dependent voltage.

As also disclosed in Non Patent Literature 1, when the ionic strength in a particular MRM transition is observed while changing the CE value in a triple quadrupole mass spectrometer, a CE value that leads to the maximum ionic strength, i.e., an optimal CE value differs according to MRM transition. The ionic strength changes in the form of a peak with respect to changes in CE value; however, the larger the CE value, the wider the peak tends to be. Accordingly, if the CE value is changed by the same step width, the amount of change in ionic strength per step width is large in a range in which the CE value is relatively small, and the amount of change in ionic strength per step width is small in a range in which the CE value is relatively large. That is, in a range in which the CE value is relatively large, the change in ionic strength is small even if measurement is performed using a small step width; therefore, it can be said that there is not much meaning in making the step width small.

On the other hand, in a case where the analyzer according to the first aspect of the present invention is applied to a tandem quadrupole mass spectrometer, the analysis controller controls the units of the analyzer to perform analysis using each of multiple CE values determined so that the rate of change in CE value is approximately constant. By determining multiple CE values so that the rate of change in CE value is approximately constant, the step width is small in a range in which the CE value is small and large in a range in which the CE value is relatively large.

Incidentally, the reason of using the term “approximately constant” here is because, for example, in a case of performing a process such as round-off, round-down, or round-up to round a numerical value of the parameter value, the rate of change is not constant in the strict sense of the word. If such a rounding process is performed, the step width is constant in each predetermined CE value range, and is increased step-by-step with respect to each CE value range from a certain CE value range in a direction of a lager CE value.

The larger the CE value, the larger the step width of the CE value; therefore, if the step width when the CE value is small is configured to be the same as that in a conventional analyzer, i.e., a constant step width, it requires fewer measurements than the conventional analyzer. Then, the optimal value determining unit finds an optimal value of the value of the parameter based on an analysis result for each of different numerical values of the parameter value obtained under control of the analysis controller. In an example of the above-described tandem quadrupole mass spectrometer, respective ionic strengths of product ions obtained by using different CE values are compared, and a CE value that leads to the maximum strength may be an optimal value. As described above, in a range in which the CE value is large, a change in the ionic strength with respect to changes in CE value is gradual; therefore, in a case where the maximum point of ionic strength is present in the range in which the CE value is large, a CE value that leads to the ionic strength close to the true maximum point of ionic strength can be accurately obtained even if the step width of the CE value is large. That is, it does not fail to find an optimal value of the CE value even through fewer measurements.

Furthermore, an analyzer according to the second aspect of the present invention developed for solving the previously described problem performs analysis of a sample while changing a value of a parameter that is one of analysis conditions and acquires information on the sample based on obtained analysis results, and includes:

a) an analysis controller that controls units of the analyzer to perform analysis using each of multiple numerical values determined so that a rate of change in numerical value to be the value of the parameter is approximately constant and acquires respective analysis results; and

b) an analysis result processing unit that acquires information on the sample based on a set of the analysis results obtained under control of the analysis controller or changes in analysis results with respect to changes in value of the parameter.

Also in this second aspect, the numerical value is changed by not a constant step width but a variable step width that allows the rate of change in numerical value to be approximately constant, just like the first aspect.

As described above, in a triple quadrupole mass spectrometer, the width of a peak that appears on a graph showing a relationship between change in CE value and ionic strength tends to be increased with increasing CE value. This means that the larger the CE value, the smaller the change of the form of dissociation of product ions with respect to the same step width. Accordingly, even if the measurement is performed by using a small step width in a range in which the CE value is large, a difference in analysis result is small. In other words, in a range in which the CE value is large, even if the step width is increased, it is unlikely to fail to find a specific analysis result, and proper information on the sample can be acquired.

In a case where the analyzer according to the second aspect of the present invention is applied to a tandem quadrupole mass spectrometer, the analysis results are mass spectrums, and the analysis result processing unit can be configured to integrate multiple mass spectrums obtained under different values of the parameter. When the mass spectrums are integrated, respective intensities of peaks on the multiple mass spectrums may be just added together; alternatively, according to the intended use, an appropriate process, such a process of adding an appropriate weight to the intensity or a process of removing an unwanted known peak, may be added.

Furthermore, as another example, the analysis results are a strength signal of a particular ion, and the analysis result processing unit may be configured to create a graph showing a change of an ionic strength signal with respect to changes in value of the parameter. According to this configuration, as disclosed in Non Patent Literature 1, a graph specific to the structure of a target substance in a sample can be created through fewer measurements, i.e., more efficiently than a conventional configuration.

### Advantageous Effects of Invention

According to the analyzer according to the first aspect of the present invention, it is possible to find an optimal value of the value of the parameter, such as the CE value, through fewer measurements than a case of changing the numerical value to be the value of the parameter by a constant step width.

Furthermore, according to the analyzer according to the second aspect of the present invention, it is possible to obtain a proper analysis result through fewer measurements when information on the sample is acquired based on results of measurements or analyses performed under multiple different values of the parameter.

### BRIEF DESCRIPTION OF DRAWINGS

FIG. 1 is a schematic configuration diagram of a triple quadrupole mass spectrometer that is a first embodiment of the present invention.

FIG. 2 is a schematic diagram showing changes in CE value in tuning of the CE value in the triple quadrupole mass spectrometer in the first embodiment and the conventional device.

FIG. 3 is a diagram showing an example of the CE value set in tuning of the CE value in the triple quadrupole mass spectrometer in the first embodiment.

FIG. 4 is a graph showing a relationship between CE value and ionic strength in a specific MRM transition in the triple quadrupole mass spectrometer.

FIG. 5 is a schematic configuration diagram of a triple quadrupole mass spectrometer that is a second embodiment of the present invention.

FIG. 6 is an explanatory diagram of a mass spectrum integration process in the triple quadrupole mass spectrometer that is the second embodiment of the present invention.

FIG. 7 is a schematic configuration diagram of a triple quadrupole mass spectrometer that is a third embodiment of the present invention.

FIG. 8 is a diagram showing an example of a graph showing ionic strength changes created in the triple quadrupole mass spectrometer that is the third embodiment of the present invention.

### DESCRIPTION OF EMBODIMENTS

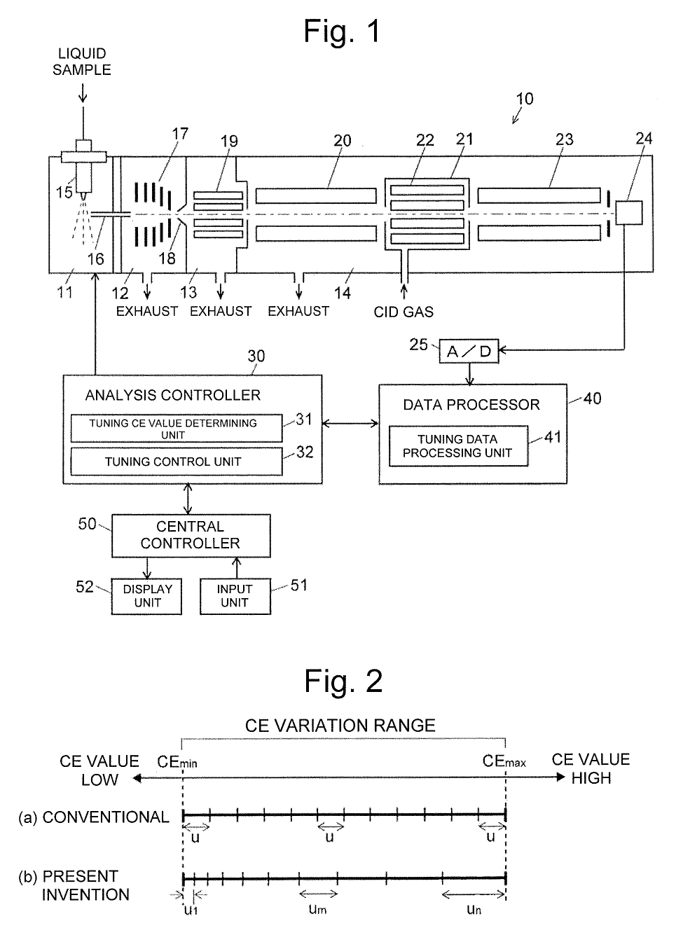

A triple quadrupole mass spectrometer that is a first embodiment of the present invention is described below with reference to accompanying drawings. FIG. 1 is a schematic configuration diagram of the triple quadrupole mass spectrometer in the first embodiment.

A mass spectrometer 10 in the present embodiment has a configuration of a multi-stage differential exhaust system in which first and second intermediate vacuum chambers 12 and 13 of which the degree of vacuum is increased step-by-step are provided between an ionization chamber 11 kept at substantially atmospheric pressure and a high-vacuum analysis chamber 14 evacuated by a high-performance vacuum pump (not shown). An ESI ionization probe 15 for spraying a sample solution while applying an electric charge to the sample solution is installed in the ionization chamber 11, and the ionization chamber 11 and the next-stage first intermediate vacuum chamber 12 are communicated through a small-diameter heating capillary 16. The first and second intermediate vacuum chambers 12 and 13 are separated by a skimmer 18 having a small hole in its apex, and ion lenses 17 and 19 for transporting ions to a subsequent stage while converging the ions are installed in the first and second intermediate vacuum chambers 12 and 13, respectively. In the analysis chamber 14, quadrupole mass filters 20 and 23 and an ion detector 24 are installed. The quadrupole mass filters 20 and 23 are provided on opposite sides of a collision cell 21 in which a multipole ion guide 22 is installed; the quadrupole mass filter 20 is provided in a stage in front of the collision cell 21, and the quadrupole mass filter 23 is provided in a stage subsequent to the collision cell 21.

In this mass spectrometer 10, when a sample solution has reached the ESI ionization probe 15, the sample solution with an electric charge applied is sprayed from the distal end of the probe 15. The sprayed charged droplets are atomized by being broken up by electrostatic forces and ions derived from a sample are ejected in the process of the atomization. The generated ions are sent to the first intermediate vacuum chamber 12 through the heating capillary 16, converged by the ion lens 17, and sent to the second intermediate vacuum chamber 13 through the small hole in the apex of the skimmer 18. Then, the ions derived from the sample are converged by the ion lens 19, sent to the analysis chamber 14, and introduced into a space in a direction of the long axis of the first-stage quadrupole mass filter 20. Incidentally, ionization may be naturally performed not only by ESI, but also by APCI or APPI.

In MS/MS analysis, respective predetermined voltages (superposed voltages of a high-frequency voltage and a direct-current voltage) are applied to rod electrodes of the first-stage quadrupole mass filter 20 and the second-stage quadrupole mass filter 23, and CID gas is supplied into the collision cell 21 so as to keep the gas pressure in the collision cell 21 at a predetermined level. Of various types of ions sent into the first-stage quadrupole mass filter 20, only ions having a particular mass-to-charge ratio according to the voltage applied to each rod electrode of the first-stage quadrupole mass filter 20 are allowed to pass through the filter 20 and be introduced, as precursor ions, into the collision cell 21. The precursor ions are dissociated by colliding with the CID gas in the collision cell 21, thereby various types of product ions are generated. The form of the dissociation at this time depends on dissociation conditions such as collision energy and the gas pressure in the collision cell 21; therefore, the types of product ions generated when the CE value is changed also vary. When the generated various types of product ions are introduced into the second-stage quadrupole mass filter 23, only product ions having a particular mass-to-charge ratio according to the voltage applied to each rod electrode of the second-stage quadrupole mass filter 23 pass through the filter 23, reach the ion detector 24, and are detected.

A detection signal from the ion detector 24 is converted into a digital value by an A/D converter 25, and the digital value is input to a data processor 40. The data processor 40 includes a tuning data processing unit 41 as a functional block. Furthermore, an analysis controller 30 that controls respective operations of units includes, as a functional block, a tuning CE value determining unit 31 and a tuning control unit 32. A central controller 50, to which an input unit 51 and a display unit 52 are attached, serves as an input/output interface and an overall controller. Incidentally, some of functions such as the central controller 50, the analysis controller 30, and the data processor 40 can be realized by executing dedicated application software on a general-purpose personal computer used as a hardware resource, where the application software has been installed on the computer in advance.

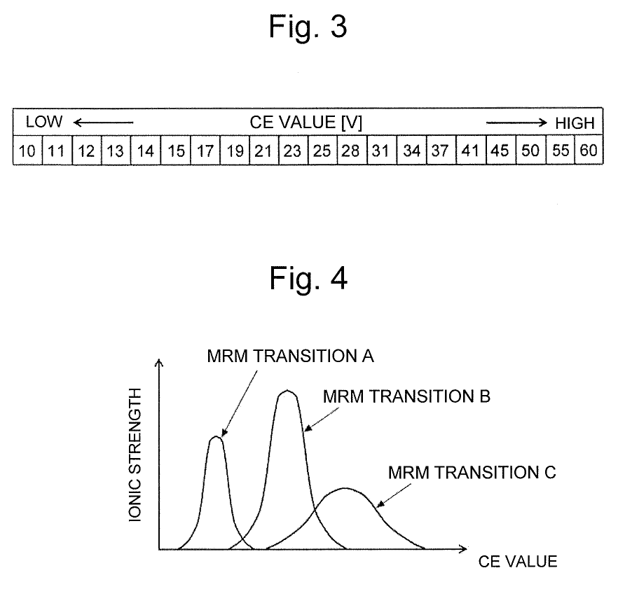

Subsequently, the operation at the time of tuning of CE value that is characteristic of the triple quadrupole mass spectrometer in the present embodiment is described with reference to FIGS. 2 to 4. FIGS. 2 to 4 are explanatory diagrams of tuning of the CE value in the triple quadrupole mass spectrometer in the present embodiment. FIG. 2 is a schematic diagram showing changes in CE value in tuning of the CE value. FIG. 3 is a diagram showing an example of the CE value set in tuning of the CE value. FIG. 4 is a graph showing a relationship between CE value and ionic strength in a specific MRM transition.

For example, when an instruction to execute tuning of the CE value has been issued from the central controller 50 to the analysis controller 30 based on a user's instruction from the input unit 51, the tuning CE value determining unit 31 determines a CE value to be subjected to MRM measurement according to predetermined MRM transition as follows.

For example, as described in Non Patent Literature 1, it is known that when respective relationships between CE value and ionic strength in different MRM transitions are examined in the triple quadrupole mass spectrometer, a graph like the one shown in FIG. 4 is obtained. As can be seen from FIG. 4, the shape of a peak indicating a change in the ionic strength roughly conforms to the Gaussian distribution; however, its peak width increases with increasing CE value. That is, when the CE value is relatively large, a change in the ionic strength is more gradual than when the CE value is small. Conventionally, in tuning of the CE value, the step width u of the CE value to be subjected to MRM measurement is constant as shown in FIG. 2(a) independent of the magnitude of the CE value; however, if a change in the ionic strength is gradual as described above, there is not much meaning in making the step width small, and even if the step width is increased, it is possible to properly apprehend a change in the ionic strength. Accordingly, here, the step width is not constant and is increased to be wider in a range in which the CE value is large than a range in which the CE value is small as shown in FIG. 2(b) (here, uₙ>uₘ>u₁).

That is, the tuning CE value determining unit 31 determines the step width so that the rate of change in the CE value becomes nearly a target value in a CE value variation range (CEₘᵢₙ to CEₘₐₓ) in which the CE value is changed that has been set by the user or automatically determined as shown in FIG. 2. Here, when a certain CE value is denoted by U₁, and a CE value larger by one step than the CE value U₁ is denoted by U₂, a rate of change is (U₂−U₁)/U₂ or (U₂−U₁)/U₁. Therefore, as shown in FIG. 2(b), the larger the CE value, the larger U₂−U₁, i.e., the step width. Incidentally, FIG. 2 just shows a concept, and the step width u₁ where the CE value is small in the CE value range is not limited to be smaller than the step width u in the conventional mass spectrometer.

The smaller the target value of the rate of change in the CE value, the relatively smaller the step width of the CE value, which increases the likelihood of being able to certainly apprehend the maximum point of the ionic strength; however, this increases the number of measurements. Accordingly, the target value of the rate of change in the CE value may be a certain fixed value, such as 10% or 5%, or may be configured to be able to be appropriately set or changed by the user or to be automatically determined to be an appropriate target value. When the target value is automatically determined, for example, the total number of analyses in the entire CE value variation range is determined in advance, and a target value of the rate of change in the CE value can be calculated from the total number of analyses and the CE value variation range.

Here, as an example, actual numerical values of the CE value when the CE value variation range (CEₘᵢₙ to CEₘₐₓ) is 10 to 60 [V], and the target value of the rate of change is 10% are shown in FIG. 3. However, to prevent voltage adjustment control from becoming complex, the CE value is rounded to the nearest integer. Therefore, when the CE value is in a range of 10 to 15 [V], the step width is equally 1 [V]; when the CE value is in a range of 15 to 25 [V], the step width is equally 2 [V]; the step width is increased step-by-step. That is, it does not mean that the adjacent step width is always increased with increasing CE value. In other words, here, each CE value is calculated so that the rate of change in the CE value is constant (10%); however, actual CE values are not constant in the rate of change and are just approximately constant.

When the CE value to be subjected to MRM measurement has been determined as described above, the tuning control unit 32 controls the units of the mass spectrometer 10 to perform MRM measurement under a predetermined MRM transition with respect to a sample. At this time, voltage applied to the rod electrodes of the first-stage quadrupole mass filter 20 is set so that precursor ions having a particular mass-to-charge ratio specified in the MRM transition pass through the mass filter 20. Furthermore, voltage applied to the rod electrodes of the second-stage quadrupole mass filter 23 is set so that product ions having a particular mass-to-charge ratio specified in the same MRM transition pass through the mass filter 23. Moreover, direct-current voltage applied to the ion guide 22 (or an inlet electrode of the collision cell 21) is switched so that the CE value is sequentially switched to, for example, the value shown in FIG. 3. Then, with each switching of the CE value, data of a strength signal of each product ion having passed through the second-stage quadrupole mass filter 23 is input to the data processor 40. This data is temporarily stored in a memory in the tuning data processing unit 41.

When ionic strength signal data for all determined CE values has been obtained, the tuning data processing unit 41 compares the ionic strength with respect to each CE value, and finds a CE value that leads to the maximum strength. Then, the found CE value is stored as an optimal value of the CE value with respect to the MRM transition. As can be seen from FIG. 4, different MRM transitions differ in optimal value of the CE value; therefore, in a case where it is necessary to find respective optimal values of CE values for multiple MRM transitions, MRM measurements for the different CE values are performed as described above with respect to each MRM transition, and a CE value that leads to the maximum ionic strength is found based on results of the measurements.

As described above, in the triple quadrupole mass spectrometer in the present embodiment, when tuning of the CE value is performed, the step width of the CE value is not constant but variable, and is increased in a range in which the CE value is large. In an example of FIG. 3, the number of CE values to be subjected to MRM measurement is twenty; however, for example, in a case where the step width is constantly 1 [V], fifty-one MRM measurements are required to cover the entire same CE value variation range. In this way, in the triple quadrupole mass spectrometer in the present embodiment can considerably reduce the number of measurements and accurately find the CE value that leads to the maximum ionic strength, and automatically set optimal analysis conditions.

Incidentally, tuning of the CE value is described in the above description; however, it is obvious that a similar method can be applied to optimization of respective values of other various control parameters in a mass spectrometer, such as cone voltage or orifice voltage applied to a skimmer or the like with a sampling cone or orifice for transporting ions to a subsequent stage formed in its apex and declustering potential, and optimization of respective values of control parameters in various analyzers other than a mass spectrometer.

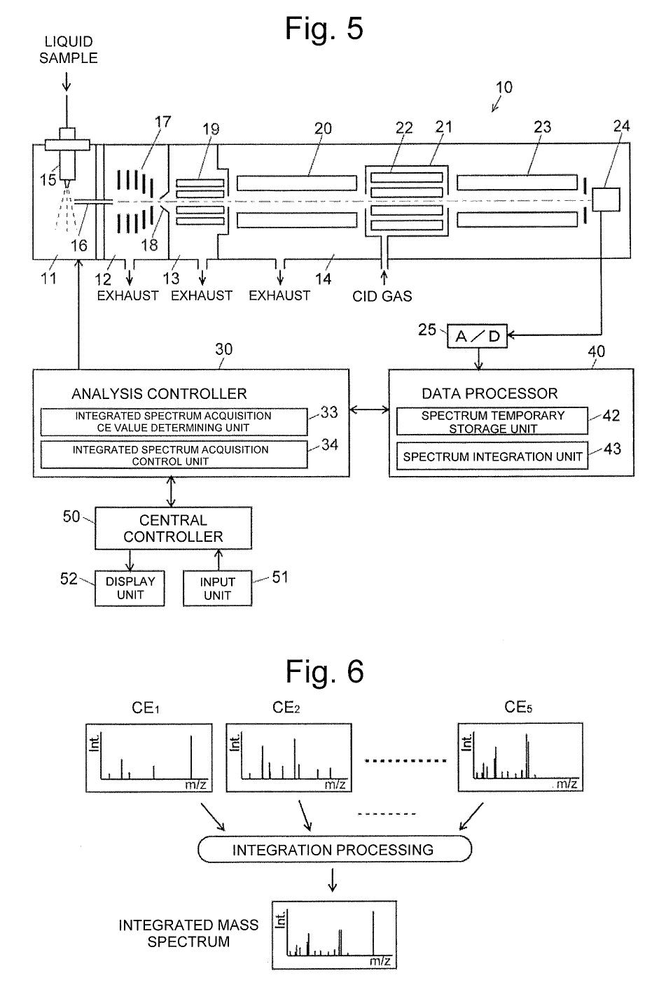

Subsequently, a triple quadrupole mass spectrometer that is a second embodiment of the present invention is described with reference to accompanying drawings. FIG. 5 is a schematic configuration diagram of the triple quadrupole mass spectrometer in the second embodiment; the same component as the triple quadrupole mass spectrometer in the first embodiment is assigned the same reference numeral, and its detailed description is omitted.

In this triple quadrupole mass spectrometer in the second embodiment, not at the time of tuning of the CE value to be optimized but when multiple mass spectrums (MS/MS spectrums) obtained by performing product scan measurement under different CE values is integrated to create one mass spectrum, a CE value determining method similar to the first embodiment is used. Accordingly, the analysis controller 30 includes an integrated spectrum acquisition CE value determining unit 33 and an integrated spectrum acquisition control unit 34, and the data processor 40 includes a spectrum temporary storage unit 42 and a spectrum integration unit 43.

For example, when an instruction to perform an integrated spectrum creating process has been issued from the central controller 50 to the analysis controller 30 based on a user's instruction from the input unit 51, just like the tuning CE value determining unit 31 in the first embodiment, the integrated spectrum acquisition CE value determining unit 33 determines multiple CE values to be subjected to product ion scan measurement. However, in general, the number of CE values to be subjected to product ion scan measurement at this time may be smaller than the number of CE values to be subjected to MRM measurement in tuning of the CE value, and a few to about ten CE values at the most are sufficient. Therefore, the target value of the rate of change in the CE value may be larger than the target value in tuning of the CE value; for example, the target value of the rate of change in the CE value may be 50%.

When the CE values have been determined, the integrated spectrum acquisition control unit 34 controls the units of the mass spectrometer 10 to perform product ion scan measurement on certain precursor ions of a sample. At this time, voltage applied to the rod electrodes of the first-stage quadrupole mass filter 20 is set so that precursor ions having a particular mass-to-charge ratio specified in advance pass through the mass filter 20. Furthermore, voltage applied to the rod electrodes of the second-stage quadrupole mass filter 23 is scanned so that mass scanning over a predetermined mass-to-charge ratio range is performed. Moreover, direct-current voltage applied to the ion guide 22 (or the inlet electrode of the collision cell 21) is switched so that the CE value is sequentially switched to a determined value. Then, with each switching of the CE value, product ion spectrum data over the predetermined mass-to-charge ratio range is input to the data processor 40. This data is temporarily stored in the spectrum temporary storage unit 42 in a manner corresponding to the CE value.

When product ion spectrum data for all determined CE values has been obtained, the spectrum integration unit 43 reads out all the product ion spectrum data obtained with respect to each CE value from the storage unit 42, and creates one mass spectrum by integrating the data as shown in FIG. 6. As the simplest integration processing, simply, ionic strengths in all mass spectrums are added together with respect to each mass-to-charge ratio, and the ionic strength axis is adjusted appropriately, and then a mass spectrum is created. Furthermore, an appropriate process, such a process of adding an appropriate weight to the ionic strength as needed and adding weighted ionic strengths together, may be added.

If the step width of the CE value is constant as is the case for a conventional mass spectrometer, a mass spectrum having a bias in the ionic strength, such as a mass spectrum in which the amount of product ions that are likely to be generated particularly when the CE value is large is increased, tends to be created. To this, by increasing the step width with increasing CE value, it is likely to be specific one in which respective mass spectrums for the CE values show a low similarity to one another. Accordingly, it is possible to create an integrated mass spectrum in which various product ions are observed without being biased.

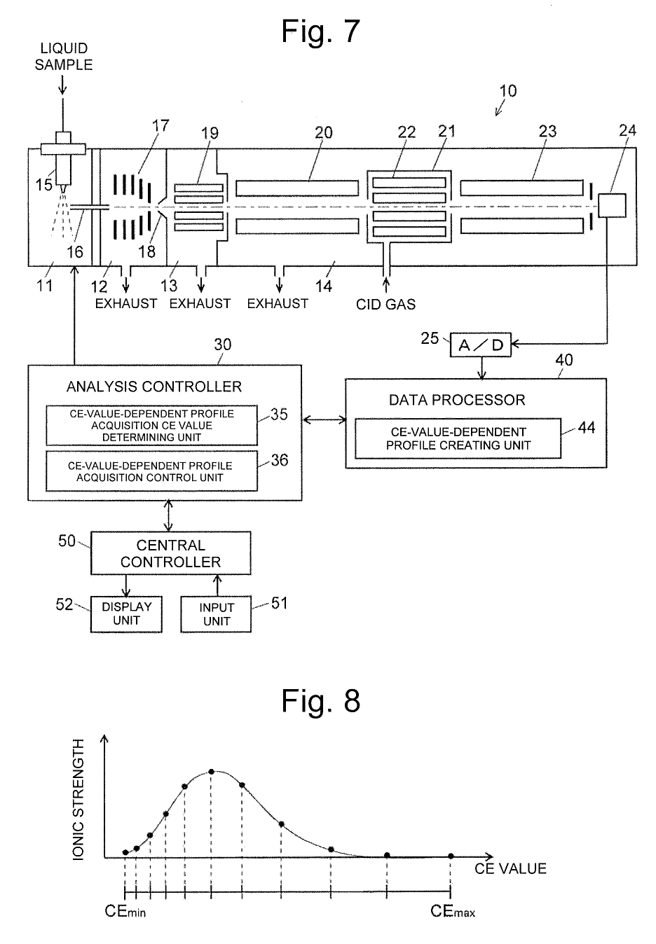

Subsequently, a triple quadrupole mass spectrometer that is a third embodiment of the present invention is described with reference to accompanying drawings. FIG. 7 is a schematic configuration diagram of the triple quadrupole mass spectrometer in the third embodiment; the same component as the triple quadrupole mass spectrometer in the first embodiment is assigned the same reference numeral, and its detailed description is omitted.

In this triple quadrupole mass spectrometer in the third embodiment, not at the time of tuning of the CE value to be optimized but when a profile showing changes in the ionic strength obtained through MRM measurement under each CE value changed is created, a CE value determining method similar to the first embodiment is used. Accordingly, the analysis controller 30 includes a CE-value-dependent profile acquisition CE value determining unit 35 and a CE-value-dependent profile acquisition control unit 36, and the data processor 40 includes a CE-value-dependent profile creating unit 44.

For example, when an instruction to perform an integrated spectrum creating process has been issued from the central controller 50 to the analysis controller 30 based on a user's instruction from the input unit 51, just like the tuning CE value determining unit 31 in the first embodiment, the CE-value-dependent profile acquisition CE value determining unit 35 determines multiple CE values to be subjected to MRM measurement. The number of CE values to be subjected to MRM measurement at this time may be about the same as the number of CE values to be subjected to MRM measurement in tuning of the CE value, and therefore, the target value of the rate of change in the CE value may also be about the same as the target value in tuning of the CE value.

When the CE values have been determined, just like the first embodiment, the CE-value-dependent profile acquisition control unit 36 sequentially performs MRM measurement of a target sample with respect to each of the determined CE values in accordance with a preset MRM transition. Ionic strength data obtained through the MRM measurement under the different CE values is input to the CE-value-dependent profile creating unit 44. The CE-value-dependent profile creating unit 44 creates a graph showing a relationship between CE value and ionic strength, i.e., a CE-value-dependent profile like the one shown in FIG. 8 based on the obtained data. In a case where the target sample is, for example, glycan, the CE-value-dependent profile is specific to the glycan structure. Accordingly, the user can infer the glycan structure based on the CE-value-dependent profile obtained in this way.

Furthermore, the embodiments described above are all an example of the present invention, and it is obvious that in parts other than those described above, any modification, addition, or alteration made appropriately within the gist of the invention will be included in claims discussed herein.

### REFERENCE SIGNS LIST

10 . . . Mass Spectrometer
11 . . . Ionization Chamber
12 . . . First Intermediate Vacuum Chamber
13 . . . Second Intermediate Vacuum Chamber
14 . . . Analysis Chamber
15 . . . ESI Ionization Probe
16 . . . Capillary
17, 19 . . . Ion Lens
18 . . . Skimmer
20 . . . First-Stage Quadrupole Mass Filter
21 . . . Collision Cell
22 . . . Multipole Ion Guide
23 . . . Second-Stage Quadrupole Mass Filter
24 . . . Ion Detector
25 . . . A/D Converter
30 . . . Analysis Controller
31 . . . Tuning CE Value Determining Unit
32 . . . Tuning Control Unit
33 . . . Integrated Spectrum Acquisition CE Value Determining Unit
34 . . . Integrated Spectrum Acquisition Control Unit
35 . . . CE-Value-Dependent Profile Acquisition CE Value Determining Unit
36 . . . CE-Value-Dependent Profile Acquisition Control Unit
40 . . . Data Processor
41 . . . Tuning Data Processing Unit
42 . . . Spectrum Temporary Storage Unit
43 . . . Spectrum Integration Unit
44 . . . CE-Value-Dependent Profile Creating Unit
50 . . . Central Controller
51 . . . Input Unit
52 . . . Display Unit

1. An analyzer having a function of optimizing a value of a parameter that is one of analysis conditions so as to produce an excellent analysis result, the analyzer comprising:
a) an analysis controller that controls units of the analyzer to perform analysis using each of multiple numerical values determined so that when an absolute value of a numerical value to be the value of the parameter is relatively small, the numerical value is changed by a small change width; when an absolute value of a numerical value is relatively large, the larger the absolute value, the larger a change width the numerical value is changed by and acquires respective analysis results; and
b) an optimal value determining unit that finds an optimal value of the value of the parameter based on the analysis results obtained under control of the analysis controller.

2. The analyzer according to claim 1, wherein the value of the parameter is a value of voltage.

3. The analyzer according to claim 2, wherein the value of the parameter is a value of compound-dependent voltage.

4. The analyzer according to claim 2, wherein
the analyzer is a mass spectrometer, and
the value of the parameter is a value of voltage for manipulating ions that are an analysis object.

5. The analyzer according to claim 4, wherein
the analyzer is a mass spectrometer including a collision cell in which ions derived from a sample are dissociated, and
the value of the parameter is a value of voltage that determines a value of collision energy used when ions are dissociated in the collision cell.

6. The analyzer according to claim 4, wherein the value of the parameter is a value of voltage applied to an ion transport optical system for transporting the ions that are an analysis object to a subsequent stage.

7. An analyzer that performs analysis of a sample while changing a value of a parameter that is one of analysis conditions and acquires information on the sample based on obtained analysis results, the analyzer comprising:
a) an analysis controller that controls units of the analyzer to perform analysis using each of multiple numerical values determined so that when an absolute value of a numerical value to be the value of the parameter is relatively small, the numerical value is changed by a small change width; when an absolute value of a numerical value is relatively large, the larger the absolute value, the larger a change width the numerical value is changed by and acquires respective analysis results; and
b) an analysis result processing unit that acquires information on the sample based on a set of the analysis results obtained under control of the analysis controller or changes in analysis results with respect to changes in value of the parameter.

8. The analyzer according to claim 7, wherein
the analyzer is a mass spectrometer including a collision cell in which ions derived from the sample are dissociated, and
the value of the parameter is a value of collision energy used when ions are dissociated in the collision cell.

9. The analyzer according to claim 8, wherein
the analysis results are mass spectrums, and
the analysis result processing unit integrates mass spectrums obtained under different values of the parameter.

10. The analyzer according to claim 8, wherein
the analysis results are a strength signal of a particular ion, and
the analysis result processing unit creates a graph showing a change of an ionic strength signal with respect to changes in value of the parameter.

11. The analyzer according to claim 1, wherein the determined multiple numerical values to be the value of the parameter are approximately constant in a ratio of each of the numerical values to a change width.

12. The analyzer according to claim 7, wherein the determined multiple numerical values to be the value of the parameter are approximately constant in a ratio of each of the numerical values to a change width.

13. The analyzer according to claim 3, wherein
the analyzer is a mass spectrometer, and
the value of the parameter is a value of voltage for manipulating ions that are an analysis object.
